(19) United States
(12) Patent Application Publication
(10) Pub. No.: US 2007/0068062 A1
(43) Pub. Date: Mar. 29, 2007

(54) Strike indicator

(76) Inventor: Dan Zeglen, Green River, WY (US)

Correspondence Address: MEREK, BLACKMON & VOORHEES, LLC, 673 S. WASHINGTON ST., ALEXANDRIA, WV, 22314, US

(21) Appl. No.: 11/523,082

(22) Filed: Sep. 19, 2006

Related U.S. Application Data
(60) Provisional application No. 60/719,608, filed on Sep. 23, 2005.

(51) Int. Cl. A01K 97/12

(52) U.S. Cl. 43/17

(57) ABSTRACT

A strike indicator that can be suspended from a fishing line. The strike indicator includes a hanger for easily releasable attachment to the fishing line. The most preferred embodiment of the invention includes a buoyant body portion and a weight. In the most preferred embodiment, the strike indicator is used by hooking the hanger over the fishing line between the first and second guides causing the line to sag downwardly a sufficient amount so that when a fish is hooked and applies tension to the line, the strike indicator is pulled sharply upward and becomes disengaged with the line so that the strike indicator does not interfere with reeling in the fish.

### FIELD OF THE INVENTION

The present invention relates to a method and apparatus for providing a visual signal of a strike for use while fishing with a fishing rod.

### BACKGROUND OF THE INVENTION

It is common to use a rod and reel combination for fishing from a boat or on the bank of a lake or stream. Conventionally, a rod includes a reel securely attached at the bottom end of the rod. The reel contains a quantity of fishing line which is threaded through eyelets on the fishing rod which guide the fishing line along the length of the rod. Fishing gear of this type is of course well known in the art. The preceding description is not intended to limit the invention, but is merely illustrative of fishing gear in general which may be used with the method and apparatus taught by the invention.

In order to detect a strike when fishing, it is generally necessary to either to hold the rod and feel for the fish taking the bait or see the effect on the line or rod. It is generally more effective to feel the line for the earliest indication of a fish taking the bait. However, there are times when holding the rod is less desirable such as when fishing is slow or when fishing with multiple rods. During these times, it is common to prop up the rod with a stick or similar device so that the rod tip is elevated above the handle. In this way bending of the rod tip can be observed so that a strike can be visually detected. During windy conditions or when the water is choppy, the line is moved by the wind and/or waves and visually detecting the strike can be difficult since the rod tip tends to bounce in response to the wind and wave action.

The prior art has provided numerous versions of strike indicating devices which are activated by increased tension on the fishing line caused by a fish taking the bait. However, these devices have generally been unduly complex involving electronic mechanisms or requiring that the fishing line be threaded through them, thus becoming part of the rod and reel combination and remaining attached to the line while the fish is being reeled in. It is a better practice to avoid extraneous parts which interfere with catching the fish after the fish has been hooked.

Therefore it can be seen that there is a need for an improved strike indicator which operates simply and effectively and can be easily removed from the rod and reel combination when a fish is hooked.

### OBJECTS AND SUMMARY OF THE INVENTION

It is therefore an object of the invention to provide a method and apparatus for providing a visual indication of a strike while fishing with a rod and reel combination.

Another object of the invention is to provide a strike indicator having variable weighting for adjusting the strike indicator according to weather conditions and fish size.

Yet another object of the invention is to provide a strike indicator that releases from the fishing line when a fish is hooked.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

Additional objects and advantages of the invention will be apparent from the following description and accompanying drawings.

In summary, the invention pertains to a strike indicator that can be suspended from a fishing line. The strike indicator includes a hanger for easily releasable attachment to the fishing line. The most preferred embodiment of the invention includes a buoyant body portion and a weight. In the most preferred embodiment, the strike indicator is used by hooking the hanger over the fishing line between the first and second guides causing the line to sag downwardly a sufficient amount so that when a fish is hooked and applies tension to the line, the strike indicator is pulled sharply upward and becomes disengaged with the line so that the strike indicator does not interfere with reeling in the fish.

### BRIEF DESCRIPTION OF THE DRAWINGS

FIG. 1 is a perspective view of a preferred embodiment of a strike indicator positioned on the line of a fishing rod

FIG. 2 is an exploded view of the most preferred embodiment of the strike indicator showing the various parts of the assembly.

FIG. 3 is a perspective view of the most preferred embodiment of the strike indicator.

FIG. 4 is an alternative embodiment of the strike indicator.

### DESCRIPTION OF THE PREFERRED EMBODIMENT

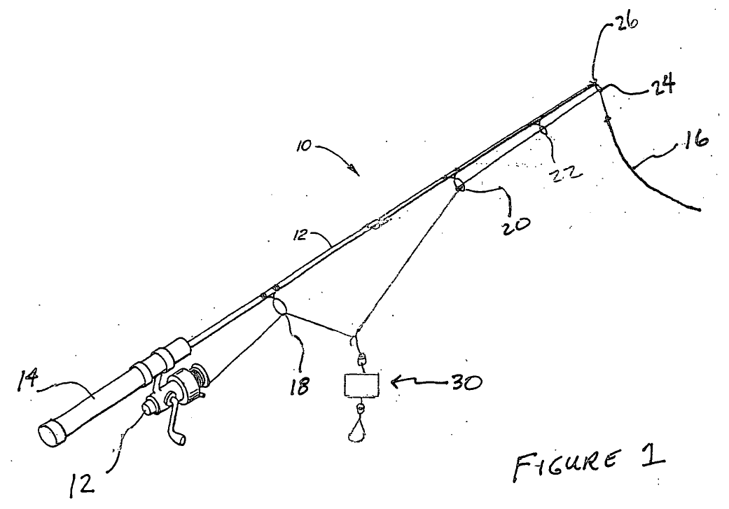

Now with reference to FIG. 1, a fishing rod 10 is shown having a reel 12 attached to a handle 14 of the rod 10 and fishing line 16 extending from the reel 12 through a series of guides 18, 20, 22 and 24 extending up the rod 10 with guide 24 being located at the tip 26 of the rod 10. It should be understood that fishing rods 10 may have many variations in length, style of handle 14 and number of guides 18-24. The rod 10 as shown in FIG. 1 merely shows a generic rod 10 design and is not intended in any way to limit the scope of the invention. When fishing, the line 16 extends outwardly from the rod tip 26 and into the body of water where the fish are hopefully swimming. In conventional practice, a fishhook is attached to the end of the fishing line 16 and is usually combined with some kind of lure which may include bait.

The strike indicator 30 is shown in FIG. 1 as it would be used during fishing. The strike indicator 30 is hung from the line 16 and the weight of the strike indicator 30 will tend to deflect the line 16 downwardly. The amount of deflection can be adjusted by adjusting the slack in the fishing line 16 and/or the weight of the strike indicator 30, which may be varied as will be described below. The weight of the lure and any sinkers attached to the line will also affect the amount of deflection. Preferably the strike indicator 30 is positioned on the line 16 between guides 18 and 20 as shown.

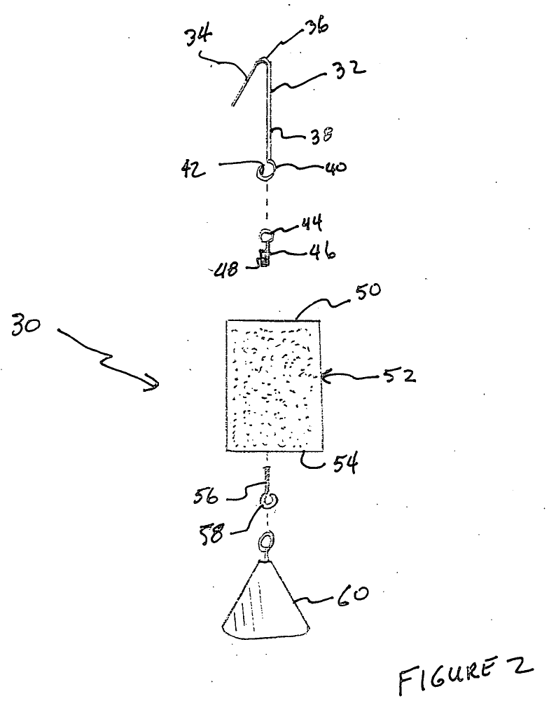

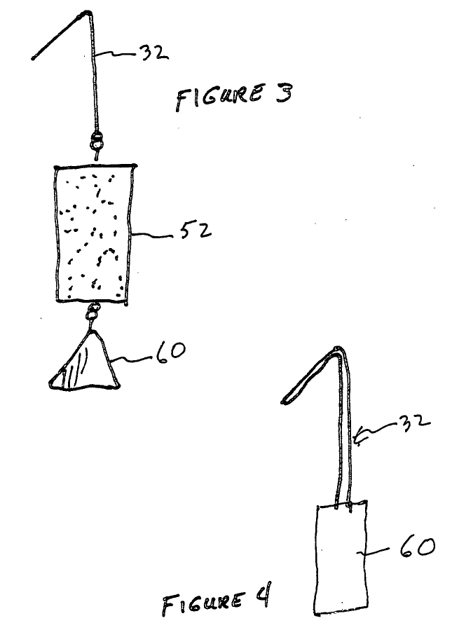

Now the strike indicator 30 will be described with reference to FIGS. 2 and 3. FIG. 2 is an exploded view of strike indicator 30. FIG. 3 is an assembled view of the strike indicator 30. The strike indicator 30 includes an open hanger 32 forming a crook and is preferably formed of wire, but other relatively stiff and shape holding materials may be used such as plastic. The hanger 32 preferably is formed having a first portion 34 connected at an angle of less than 90° to a top end 36 of a second portion 38 which is preferably of greater length than the first portion 34. The crook formed at top end 36 could also be curved. The bottom end 40 of the second portion 38 of hanger 32 preferably includes a loop 42 which permits attachment of the hanger 32 to an eye 44 of an eyebolt 46. The eyebolt 46 includes a threaded portion 48 which can be screwed into the top 50 of a body portion 52. The body portion 52 is preferably formed of cork for buoyancy, but other materials such as wood, glass, plastic or even metal may be substituted. The body portion 52 is preferably painted a bright highly visible color such a blaze orange, but may also include fluorescent or luminescent material and could include a battery powered light with a transparent lens to assist viewing at night.

Connected to the bottom 54 of the body portion 52 is another eyebolt 56 having an eyelet 58 for attachment of a weight 60. Preferably the weight 60 includes an attachment loop 62 for attaching the weight 60 to the eyelet 58.

The strike indicator 30 is used by suspending the indicator 30 by the hanger 32 by placing the hanger 32 so that the top end 36 rests on line 16. In this position, the body portion 52 and the weight 60 are suspended below the hanger 32. When a lead sinker is used for the weight 60, the size of the sinker can be varied so that the deflection of the line 16 can be adjusted. Factors affecting the amount of weight include the weight of the lure attached at the hook, the weight of the sinker used to keep the lure in position, the wind speed and wave action.

When a fish is hooked and pulls on the line 16, the slack in the line 16 is taken up. Usually, the force of the fish on the line 16 causes the entire strike indicator to pop up and disengage the line 16 and fall to the ground. Now the fish can be reeled in without any interference from the strike indicator 30. The strike indicator 30 will nearly always disengage from the line 16, but even if it fails to do so from the bouncing of the line 16 and rod 10, the indicator 30 can easily be grasped and removed since it is merely hanging on the line.

Various modifications could be made to the preferred design including eliminating the body portion 52 and having the hanger 32 connected directly to a weight 60, or a snap swivel (not shown) may be added at the connection between the hanger 32 and the eyebolt 46 and/or at the connection to the body portion 52 and the weight 60 to allow for quick interchangeability of the body portion 52 and/or weight 60.

Alternatively, the hanger 32 and the weight 60 may be formed of a single unit 62 as shown in FIG. 4. Unit 62 may be formed of metal or plastic or could be a composite material.

While this invention has been described as having a preferred design, it is understood that it is capable of further modifications, uses and/or adaptations of the invention following in general the principle of the invention and including such departures from the present disclosure as come within the known or customary practice in the art to which the present invention pertains and as maybe applied to the central features hereinbefore set forth, and fall within the scope of the invention and the limits of the appended claims.

I claim:

1. A strike indicator for use with a fishing rod and reel combination, comprising:
a) a line engaging hanger for suspending a weighted body portion from the fishing line, said line engaging hanger having an opening of sufficient size so as to easily disengage from the fishing line.

2. The strike indicator as set forth in claim 1, wherein;
a) said line engaging hanger is formed of wire having an eyelet for connecting said hanger to said weighted body portion and said weighted body portion having a first eyebolt for supporting said weighted body portion from said eyelet of said hanger.

3. The strike indicator as set forth in claim 2, wherein:
a) said weighted body portion includes a buoyant body having said a second eyebolt spaced from said first eyebolt and a weight attached to said second eyebolt.
